(19) United States
(12) Patent Application Publication
(10) Pub. No.: US 2016/0251762 A1
(43) Pub. Date: Sep. 1, 2016

(54) METHOD OF TREATING A PICKLING SOLUTION FOR A PICKLING PROCESS

(71) Applicant: CMI UVK GMBH, Montabaur (DE)

(72) Inventors: Egon SEHNER, Ransbach-Baumbach (DE); Wolfgang WALSDORF, Ettringen (DE)

(21) Appl. No.: 14/914,661

(22) PCT Filed: Aug. 27, 2014
(86) PCT No.: PCT/EP2014/068201

§ 371 Date: Feb. 26, 2016

(30) Foreign Application Priority Data
Aug. 29, 2013 (EP) 13182250.4

(51) Int. Cl. C23G 1/36; B03C 1/033; B03C 1/00; C23G 1/08; C23G 3/00

(52) U.S. Cl. CPC C23G 1/36; C23G 1/08; C23G 3/00; B03C 1/002; B03C 1/0332; B03C 1/0335; B03C 2201/18; B03C 2201/22

(57) ABSTRACT

A method of treating a pickling solution for a pickling process, wherein the pickling solution has one or more silicon compounds dispersed in the pickling solution, includes: first, providing the pickling solution to a cavity of a container; second, creating an electro-magnetic field within the container, wherein the electro-magnetic field substantially extends within the cavity; and third, treating the pickling solution provided to the cavity by the electromagnetic field such that one or more precipitates formed by the silicon compound(s) are dissolved and/or a formation of the one or more precipitates is restrained.

### CROSS-REFERENCE TO RELATED APPLICATIONS

This application is a U.S. national stage application under 35 U.S.C. §371 of International Application No. PCT/EP2014/068201, filed on Aug. 27, 2014, and claims benefit to European Patent Application No. 13 182 250.4, filed on Aug. 29, 2013. The International Application was published in English on Mar. 5, 2015, as WO 2015/028527 A1 under PCT Article 21(2).

### FIELD

The present invention relates to a method of treating a pickling solution for a pickling process.

### BACKGROUND

In pickling processes, metal surfaces are treated by removing impurities such as stains, rust or scale using pickle liquors containing strong acids. These impurities may occur during metal forming processes, in particular rolling and/or heat treatment. To this end, strong acids, also called pickle liquor, are used to descale or clean the metal surfaces. For example hydrochloric acid, sulfuric acid, nitric acid, hydrofluoric acid or mixtures of different acids may be used as pickling agents for pickling of e.g. ferrous metals, copper or aluminum alloys. The large amounts of spent acids are not only hazardous to the environment but usually also expensive. Thus it is desirable to reduce the amount of generated spent acid or even to regenerate the spent acids for reuse in various processes. However, the known pickling apparatuses have a relatively short mean time between failures, which is due to large amounts of contaminates of hazardous compounds or elements, which form deposits within devices and/or pipes of the pickling apparatus. This build up of deposits is especially very exhaustive when Silicon Steel or Electrical Steel is pickled.

### SUMMARY

An aspect of the invention provides a method of treating a pickling solution for a pickling process, the pickling solution including a silicon compound dispersed in the pickling solution, the method comprising: first, providing the pickling solution to a cavity of a container; second, creating an electro-magnetic field within the container, the electro-magnetic field substantially extending within a cavity of the container; and third, treating the pickling solution by the electro-magnetic field such that one or more precipitates formed by the silicon compound are dissolved and/or a formation of the precipitates is restrained.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates schematically a pickling apparatus according to an aspect the present invention;

FIGS. 2-8 illustrate schematically a device according to various embodiments of the present invention; and

FIG. 9 illustrates schematically a device according to an embodiment of the present invention.

FIGS. 10-11 illustrate schematically a pathway of particles during the treatment of the pickling solution according to the present invention.

### DETAILED DESCRIPTION

An aspect of the present invention provides an apparatus which improves the operation of a pickling line for pickling of silicon steel material in a pickling solution. A further aspect of the present invention provides a method of treating the pickling solution and a device for treating the pickling solution, wherein the operation time and the lifetime of the pickling apparatus are increased and the maintenance costs are reduced.

An aspect of the present invention provides a method of treating a pickling solution for a pickling process, wherein the pickling solution comprises silicon compounds dispersed in the pickling solution, wherein, in a first step, the pickling solution is provided to a cavity of a container means, wherein in a second step, an electro-magnetic field is created within the container means, wherein the electro-magnetic field substantially extends within the cavity, wherein, in a third step, the pickling solution provided to the cavity is treated by the electro-magnetic field such that precipitates formed by the silicon compounds are dissolved and/or a formation of said precipitates is restrained.

According to an aspect of the present invention, it is thereby advantageously possible to increase the lifetime of the pickling apparatus and reduce maintenance costs. Preferably, the silicon compounds are contained in a hydrochloric bath used for pickling a silicon steel material, such as work pieces, sheets or steel strips. Preferably, the used bath is recycled after concentration and subject to different pickling steps and/or regeneration steps in associated pickling and/or regeneration equipments of the pickling apparatus. For example, the pickling apparatus comprises one or more pickling and/or regeneration equipments, wherein an pickling and/or regeneration equipment of the one or more pickling and/or regeneration equipments is a pickling bath device, an acid regeneration device, a rinsing device, a mixing device, a concentrator device and/or a piping. Preferably the pickling and/or regeneration equipments are configured to transport the silicon steel material and/or to convey and/or store the pickling solution. Preferably, the container means is a conveyance device such as a tube or pipe of the piping and/or a storing device such as a tank or other means having a cavity. Preferably, the precipitates are deposits, e.g. on a wall of the container means. Preferably, in the third step, the pickling solution provided to the cavity is treated by the electro-magnetic field such that deposits formed by the silicon compounds are dissolved and/or a formation of said deposits is restrained. Preferably, the pickling solution is provided to the cavity of the container means prior to the creation of the electro-magnetic field within the container means or vice versa.

According to an aspect of the present invention, the lifetime of the pickling and/or regeneration equipments for executing a pickling and/or regeneration processes as well as the lifetime of storing and/or conveyance devices are increased by treating the pickling solution with the electro-magnetic field. The electro-magnetic field is preferably a static magnetic field or an oscillating magnetic field generated depending on an alternating current. It has been advantageously found that the device can be configured such that an interaction of the electro-magnetic field with the pickling solution dissolves precipitates formed by the silicon compounds and/or inhibits a formation of said precipitates. For example, the precipitates may be polymerized silicon compounds or silicates or other deposits comprising silicon compounds. Typically, the precipitates deposit within the pickling and/or regeneration equipments of the pickling apparatus. Moreover the precipitates or deposits are composed of rather rigid material, which are either irremovably fixed to the pickling and/or regeneration equipments or can be removed only at considerable expenses and maintenance costs. According to the present invention, the formation of such precipitates can be advantageously avoided and/or the precipitates are removed by means of the pickling and/or regeneration equipments of the pickling solution with the inventive method. Furthermore, it is advantageously possible to reduce the costs of production for high strength and/or high-grade steel, in particular for the automotive industry, wherein the high-strength and/or high-grade steel comprises approximately between 0.3% and 0.8% Silicon (Si) as an alloy component.

Preferably, the container means is a tank or a tube or a pipe, wherein the container means is at least partially or completely surrounded by a wall. Preferably, the pickling solution is conveyed through the container means at a flow speed and into a flow direction.

According to another preferred embodiment of the present invention, in the third step, the pickling solution provided to the cavity interacts with the electro-magnetic field such that the precipitates formed by the silicon compounds are dissolved and a formation of said precipitates is restrained. Preferably, this means that the precipitates formed by the silicon compounds are dissolved and a formation of said precipitates is restrained—In particular inhibited—due to the interaction of the electro-magnetic field with the silicon compounds (i.e. silicon-dioxide molecules) of the precipitates and/or the pickling solution.

According to another preferred embodiment of the present invention,
the electro-magnetic field is configured to influence a crystalline structure of said precipitates, wherein the crystalline structure of said precipitates is preferably at least partially dissolved upon interaction of the precipitates with the electromagnetic field, and/or
   the electro-magnetic field is configured to influence a polymerization reaction of the silicon compounds, wherein the polymerization reaction of the silicon compounds is preferably influenced such that the formation of said precipitates is inhibited, and/or
the electro-magnetic field is configured to influence a polarization of the silicon compounds, wherein the (e.g. ionic) polarization of the silicon compounds is preferably modulated by the electro-magnetic field, wherein the polarization of said silicon compounds is preferably modulated such that said precipitates are dissolved and/or such that the formation of said precipitates is inhibited.

According to an aspect of the present invention, it is thereby advantageously possible to inhibit or suppress the formation of said precipitates (i.e. incrustations) of (polymerized) silicon compounds within devices and/or pipes of the pickling apparatus. The formation of said precipitates on relatively hot surfaces (e.g. within heat-exchangers) and/or within pipes of the pickling apparatus is preferably inhibited. Thereby the lifetime of the pickling apparatus is increased and the maintenance costs are reduced.

According to a preferred embodiment of the present invention, in the third step, a resonant pulsation of the pickling solution is generated by the electro-magnetic field.

According to an aspect of the present invention, it is thereby advantageously possible to induce changes of a fluid flow of the pickling solution, e.g. the flow direction and/or induce turbulences. The resonant pulsation preferably comprises a pulsation frequency and/or pulsation amplitude, which is/are varied depending on a variation of the electro-magnetic field in space and/or time. Preferably, due to the resonant pulsation of the pickling solution, the flow direction is reversed at least partially such that the precipitates or deposits are dissolved, e.g. by weakening binding or adhesive forces between the particles—e.g. silicon compounds—of the pickling solution. Thus, the dissolved precipitates or deposits can be carried away with the solution more easily.

According to a preferred embodiment of the present invention, in the third step, an oscillating electro-magnetic field having an oscillation frequency and an oscillation amplitude is provided, wherein the oscillation frequency and/or oscillation amplitude is varied in time such that said precipitates are dissolved and/or such that the formation of said precipitates is inhibited.

According to another preferred embodiment of the present invention, the electro-magnetic field has a plurality of oscillation frequencies, wherein the plurality of oscillation frequencies is varied in time such that said precipitates are dissolved and/or such that the formation of said precipitates is inhibited.

According to an aspect of the present invention, it is thereby advantageously possible to configure the electro-magnetic field in such a way that—e.g. by employing a combination of time-varying oscillation frequencies of the plurality of oscillation frequencies—a relatively broad range of molecule-sizes is influenced by the electro-magnetic field such that said precipitates are dissolved and/or their formation is inhibited more efficiently.

According to another preferred embodiment of the present invention, the plurality of oscillation frequencies of the electro-magnetic field is adjusted and/or varied in time such that a crystalline structure and/or a polymerization reaction of the silicon compounds (e.g. silicon-dioxide molecules of the silicon compounds) and/or a polarization—i.e. dielectric polarization (preferably ionic polarisation)—of the silicon compounds (e.g. silicon-dioxide molecules of the silicon compounds) is influenced by the electro-magnetic field, wherein a magnet arrangement is preferably adapted to adjust the electro-magnetic field such that the crystalline structure of said precipitates is influenced (e.g. melted or dissolved) and/or the polymerization reaction of the silicon compounds is influenced (e.g. suppressed) and/or the polarization of said silicon compounds is influenced (e.g. modulated).

According to an aspect of the present invention, it is thereby advantageously possible to influence the formation of precipitates (i.e. incrustation) by means of the electro-magnetic field (having the plurality of time-varying oscillation frequencies) such that the formation of precipitates (incrustation) is completely inhibited, wherein the lifetime of the pickling apparatus of the present invention is advantageously extended.

According to an aspect of the present invention, it is thereby advantageously possible to vary the electro-magnetic field in such a way, that the interaction of said field with the solution is optimized for the treatment of the pickling solution, which comprises the silicon compounds. For example, the frequency range being varied in time is determined depending on solution properties such as ionic strength and/or flow speed of the pickling solution, wherein the optimal frequency range of the oscillating electro-magnetic field is adapted to one or more solution properties. Thereby, the method is further improved with regard to a cleaning efficiency.

According to a preferred embodiment of the present invention, in the third step, a homogeneous or inhomogeneous electro-magnetic field is provided, wherein the electro-magnetic field is varied along a longitudinal direction of the container means, wherein the cavity and/or container means mainly extends along the longitudinal direction.

According to an aspect of the present invention, it is thereby advantageously possible to subject the pickling solution to a varying electro-magnetic field, both in time and space. Preferably, the electro-magnetic field is either a static magnetic field, wherein the static magnetic field may be homogeneous or inhomogeneous—e.g. varying only in space or an oscillating magnetic field, which varies in time. Thereby, the method is further improved

According to a preferred embodiment of the present invention, in the third step, the electro-magnetic field is modulated with a modulation signal having a modulation frequency and/or a modulation amplitude and/or a modulation phase, wherein the modulation frequency and/or the modulation amplitude and/or the modulation phase of the modulation signal is/are varied in time such that said precipitates are dissolved and/or such that the formation of said precipitates is inhibited.

According to an aspect of the present invention, it is thereby advantageously possible to vary the electro-magnetic field in such a way, that the interaction of said field with the solution is optimized for the treatment of the pickling solution, which comprises the silicon compounds. For example, the modulation frequency range being varied in time is determined depending on solution properties such as ionic strength and/or flow speed of the pickling solution, wherein the optimal frequency range of the oscillating electro-magnetic field is adapted to one or more solution properties. Thereby, the method is further improved with regard to a cleaning efficiency. Preferably, the modulation frequency is approximately between 1 Hz and 1 MHz, more preferred between 50 Hz and 500 KHz, even more preferred between 75 Hz and 1.2 kHz.

According to a preferred embodiment of the present invention, the electro-magnetic field comprises a signal having a sine-wave pattern, triangle-wave pattern, sawtooth-wave pattern or square-wave pattern.

According to the present invention, it is thereby advantageously possible to provide different signal forms. It is preferred according to the present invention that a square-wave pattern is used as it effectively contains many frequencies from a few Hz to several 100 kHz. Thereby the direction of the magnetic field is preferably changed by a number of rapid oscillations past a very weak static magnet. Preferably, an electric field is additionally applied which further improves the dissolution and/or inhibition of the precipitates, preferably a pulsed electric field is used approximately at a frequency of 14 MHz and amplitude of 2 V.

According to a preferred embodiment of the present invention, in the first step, the pickling solution is conveyed through the cavity of the container means along a flow direction substantially parallel to the longitudinal direction of the cavity and/or container means, wherein the flow direction is reversed by the electro-magnetic field into a direction antiparallel to the flow direction by utilizing a magnet arrangement of magnet devices being arranged along the longitudinal direction in or at the cavity and/or circumferential around an axis, wherein the axis is substantially parallel to the longitudinal direction.

According to an aspect of the present invention, it is thereby advantageously possible to provide different types of interactions of the magnetic field with the pickling solution such as flow reversal, inducing turbulences, separating flow pathways of oppositely charged particles—e.g. ions and counter-ions, and/or collisions between the oppositely charged particles. Thereby the lifetime of the pickling apparatus is further increased and the maintenance costs further reduced. Additionally the costs of production for high strength and/or high-grade steel, in particular for the automotive industry, are kept relatively low.

According to a preferred embodiment of the present invention, the pickling solution comprises silicon compound ions and counter-ions, wherein in a fourth step, the silicon compound ions and counter-ions are separated from each other by the electro-magnetic field, wherein the silicon compound ions and counter-ions are separated depending on a variation of the magnetic field in time and/or space, wherein, in a fifth step, the silicon compound ions and counter-ions are preferably collided depending on the variation of the magnetic field in time and/or space, wherein in the fourth step and/or fifth step, the silicon compound ions and/or counter-ions are preferably moved on spiral, linear and/or sinusoid pathways.

According to an aspect of the present invention, it is thereby advantageously possible to increase the lifetime of the pickling apparatus and to reduce the maintenance costs even further. Additionally the costs of production for high strength and/or high-grade steel, in particular for the automotive industry, are kept relatively low.

According to a preferred embodiment of the present invention, in the third step, a solution property of the pickling solution is measured by a sensor, wherein the electro-magnetic field is varied in time and/or space depending on the measured solution property such that said precipitates are dissolved and/or such that a formation of said precipitates is inhibited, wherein the solution property is preferably a flow direction, flow speed, electrical conductivity, surface tension, composition and/or ionic strength of the pickling solution.

According to an aspect of the present invention, it is thereby advantageously possible to enhance the user convenience by providing a monitor and control system for further optimizing the method of treating the pickling solution. Thereby the lifetime of the pickling apparatus is further increased and the maintenance costs further reduced. Additionally the costs of production for high strength and/or high-grade steel, in particular for the automotive industry, are kept relatively low.

An aspect of the present invention is further achieved by a device for treating a pickling solution for a pickling process, wherein the device comprises a magnet arrangement and a container means, wherein the container means has a cavity, wherein the magnet arrangement is configured to create an electro-magnetic field substantially extending into the cavity of the container means, wherein the device is configured to treat the pickling solution provided to the cavity by means of the electro-magnetic field such that precipitates formed by the silicon compounds are dissolved and/or a formation of said precipitates is inhibited.

According to an aspect of the present invention, it is thereby advantageously possible to increase the lifetime of the pickling apparatus and reduce maintenance costs. Thereby the lifetime of the pickling apparatus is further increased and the maintenance costs further reduced. Additionally the costs of production for high strength and/or high-grade steel, in particular for the automotive industry, are kept relatively low.

According to another preferred embodiment of the present invention, the device is adapted to treat the pickling solution provided to the cavity by means of the electro-magnetic field such that precipitates formed by the silicon compounds are dissolved and/or a formation of said precipitates is inhibited. This means, for example, that the device comprises a magnet arrangement being adapted to adjust the electro-magnetic field such that precipitates formed by the silicon compounds are dissolved and/or a formation of said precipitates is inhibited upon interaction of the electro-magnetic field with the precipitates and/or silicon compounds.

According to a preferred embodiment of the present invention, the container means comprises a wall at least partially surrounding the cavity, wherein the magnet arrangement comprises one or more magnet device, wherein the one or more magnet devices are arranged at the wall, wherein the one or more magnet devices are disposed on the wall at an inner side of the container means, on the wall at an outer side of the container means, within the wall of the container means and/or within a box element within the cavity, wherein the one or more magnet devices of the magnet arrangement are preferably permanent magnets and/or electro magnets, wherein said electro magnet is preferably a winding spool being coiled around the container means.

According to an aspect of the present invention, it is thereby advantageously possible to provide differently configured magnetic fields being individually optimized for the pickling and/or regeneration equipments—e.g. the pickling bath tank and/or piping—of the pickling apparatus, where the device is positioned for the method of treating the pickling solution.

According to a preferred embodiment of the present invention, the at least two magnet devices of the one or more magnet devices are arranged linearly along a longitudinal direction and/or circumferential around the cavity, preferably around an axis being substantially parallel to the longitudinal direction, wherein said at least two magnet devices are preferably arranged by pairs on opposing walls.

According to an aspect of the present invention, it is thereby advantageously possible to generate a homogeneous magnetic field, wherein the field lines are substantially parallel. It is thereby furthermore advantageously possible to increase the lifetime of the pickling apparatus and reduce maintenance costs.

According to a preferred embodiment of the present invention, the device comprises a control means, preferably a control circuit, and/or a sensor, wherein the control means is configured to control the magnet arrangement and/or wherein the sensor is configured to measure a solution property of the pickling solution, wherein, preferably, the control means is configured to control the magnet arrangement depending on the solution property measured by the sensor such that said precipitates are dissolved and/or such that a formation of said precipitates is inhibited.

According to an aspect of the present invention, it is thereby advantageously possible to improve the user convenience by providing a reliable monitoring and control system. It is thereby furthermore advantageously possible to increase the lifetime of the pickling apparatus and reduce maintenance costs.

An aspect of the present invention is further achieved by a pickling apparatus for pickling of a silicon steel material in a pickling solution, wherein the pickling apparatus comprises a pickling bath device, an acid regeneration device, a rinsing device, a mixing device, a concentrator device and/or piping, wherein the pickling apparatus comprises one or more devices according to the present invention, wherein a device of the one or more devices is arranged in, on and/or at the pickling bath device, the acid regeneration device, the rinsing device, the mixing device, the concentrator device and/or the piping.

According to an aspect of the present invention, it is thereby advantageously possible to increase the lifetime of the pickling apparatus and reduce maintenance costs. Preferably, the silicon compounds are contained in a hydrochloric bath used for pickling a silicon steel material, such as work pieces, sheets or steel strips. Preferably, the used bath is recycled after concentration and subject to different treatments and regeneration steps in the associated pickling and/or regeneration equipments of the pickling apparatus, wherein the pickling and/or regeneration equipment is for example the pickling bath device, the acid regeneration device, the rinsing device, the mixing device, the concentrator device and/or the piping of the pickling apparatus.

According to a preferred embodiment of the present invention, the container means of said device is an integral part of the pickling bath device, the acid regeneration device, the rinsing device, the mixing device, the concentrator device or the piping.

According to an aspect of the present invention it is thereby advantageously possible to use the device for treating the pickling solution within various pickling and/or regeneration equipments of the pickling apparatus, wherein the pickling solution is preferably stored in and/or conveyed through the various pickling and/or regeneration equipments. Preferably, a modular system is provided by attaching the device to the pickling and/or regeneration equipments of already existing pickling apparatuses.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

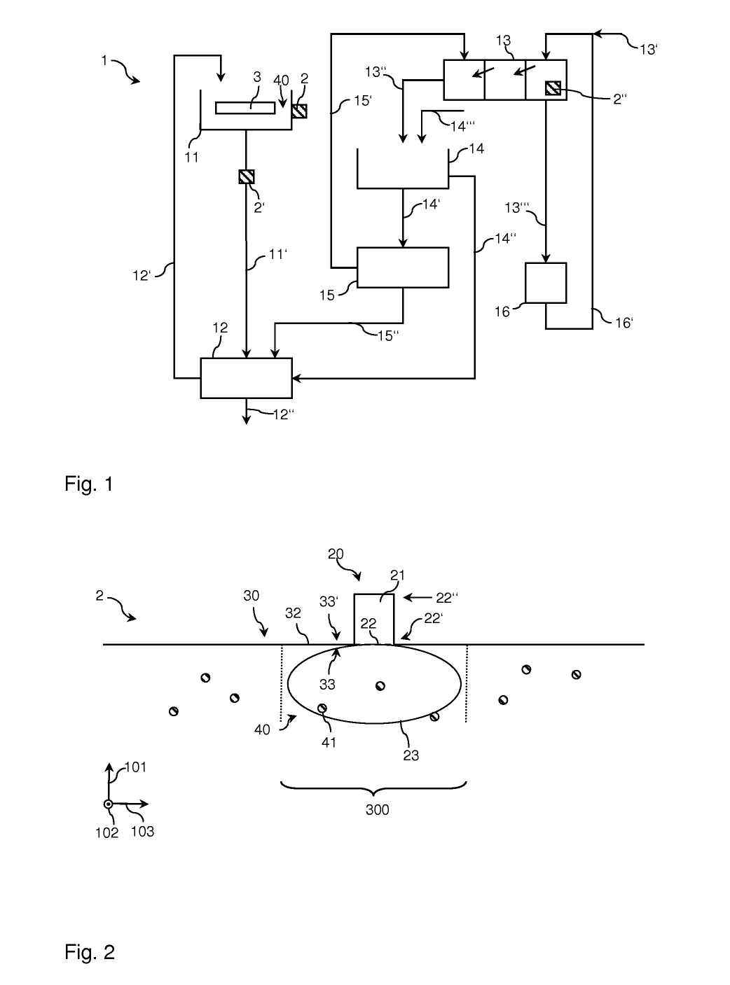

FIG. 1 schematically shows an embodiment of the pickling apparatus 1 according to the present invention. The pickling apparatus 1 is configured to execute a pickling process, wherein silicon steel material 3 is pickled in a pickling solution 40. Preferably, the silicon steel material 3 is a steel strip, sheet or other work piece. Here, the pickling apparatus 1 comprises one or more pickling and/or regeneration equipments (11, 12, 13, 14, 15, 16), i.e. a pickling bath device 11, an acid regeneration device 12, a rinsing device 13, a mixing device 14, a concentrator device 15, an ion exchange loop device 16 and/or a piping 11′, 12′, 13′, 13″, 13′″, 14′, 14″, 15′, 15″, 16′. Here, the silicon steel material 3 is pickled by the pickling solution 40, which are both provided to the pickling bath device 11, e.g. a pickling tank. The pickling solution 40 is preferably a strong acid, e.g. hydrochloric acid, hydrofluoric acid and/or nitric acid or sulfuric acid or a mixture of those. Hence, the pickling solution 40 or spent pickling solution 40 comprises silicon compounds 41 and other metal compounds 42, e.g. iron compounds dissolved in the pickling solution 40. Additionally, the pickling apparatus comprises a rinsing device 13 attached to the pickling device 11 and a regeneration system comprising an acid regeneration device 12 and an associated evaporator system 15 or concentrator 15. After pickling the silicon steel material 3, the pickling solution 40 comprising silicon compounds is supplied—as a first volume stream—to a pipe 11′ and from the pipe 11′—directly or indirectly via intermediate further equipments (not shown)—to the acid regeneration device 12, e.g. a pyrohydrolysis reactor. Optionally, a second volume stream is supplied via pipe 13″ from the rinsing device 13 to the mixing device 14, wherein the second volume stream may be mixed with a reagent (as indicated by arrow 14′″). Optionally, a third volume stream comprising metal salts is supplied to the concentrator 15 via pipe 14′ and/or to the acid regeneration device via pipe 14″. Optionally, in the concentrator 15, the stream is concentrated as much as possible in order to keep the volume flow via pipe 15″ to the acid regeneration device 12 small. Further, it is preferred that an ion exchange loop device 16 is provided, which is connected via pipes 13′″ and 16′ to the rinsing device 13 and/or to a water stream 13′.

According to a preferred embodiment, the pickling apparatus 1 comprises one or more devices 2, 2′, 2″ according to the present invention. Preferably, one or multiple devices of the one or more devices 2, 2′, 2″ is/are arranged in, on and/or at the pickling bath device 11, the acid regeneration device 12, the rinsing device 13, the mixing device 14, the concentrator device 15, the ion exchange loop device 16 and/or the piping (11′, 12′, 13′, 13″, 13″, 14′, 14″, 15′, 15″, 16′). Preferably, a container means 40 of a device of said devices 2, 2, 2″ is an integral part of the pickling bath device 11, the acid regeneration device 12, the rinsing device 13, the mixing device 14, the concentrator device 15, the ion exchange loop device 16 or the piping (11′, 12′, 13′, 13″, 13′″, 14′, 14″, 15′, 15″, 16′).

According to the embodiment shown in FIG. 1, a device 2 is attached—here at an outer side 33′—to a wall (32, 32′) (see e.g. FIG. 2) of the pickling bath device 11, a further device 2′ is arranged at a pipe 11 and another device 2″ is arranged within the rinsing device 13 (see e.g. FIGS. 6 to 8).

FIG. 2 schematically shows an embodiment of the device 2 according to the present invention. The device 2 is configured for treating a pickling solution 40 for a pickling process. The device 2 comprises a magnet arrangement 20 and a container means 30.

Preferably the container means 30 is an integral part of a pickling and/or regeneration equipment 11, 12, 13, 14, 15, 16 and/or the associated piping 11′, 12′, 13′, 13″, 13′″, 14′, 14″, 15′, 15″, 16′ of the pickling and/or regeneration equipments 11, 12, 13, 14, 15. The container means 30 has a cavity 300. Here, the cavity 300 is surrounded by a wall 32 of the container means 30—at least from one side—, wherein the wall 32 is for example a side wall or bottom wall or top wall of a pickling and/or regeneration equipment 11, 12, 13, 14, 15, e.g. the pickling bath tank 11 or of the associated pipe, e.g. pipe 11′ of said piping. Here, the wall 32 mainly extends along a plane being substantially parallel to a longitudinal direction 103 or Z-direction. Furthermore, an X-direction 101 and a Y-direction 103 is shown, wherein the X-direction 101, Y-direction 102 and Z-direction 103 are orthogonal to each other. The wall 32 has an inner side 33 and an outer side 33′, wherein the inner side 33 faces the cavity 300 and is in contact with the pickling solution 40 being provided to the container means 30. Here, the pickling solution 40 is shown having a silicon compound 41 dissolved in the solution. The silicon compound is, e.g. a particle comprising silicates.

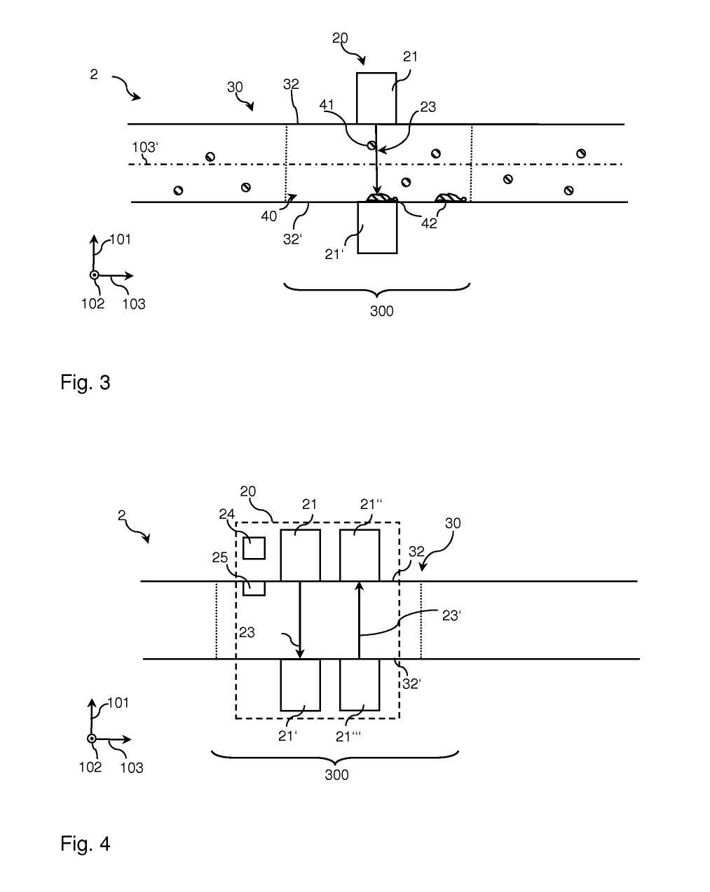

The magnet arrangement 20 is configured to create an electro-magnetic field 23 substantially extending into the cavity 300 of the container means 30. The device 2 is configured to treat the pickling solution 40 provided to the cavity 300 by means of the electro-magnetic field 23 such that precipitates 42 formed by the silicon compounds 41 are dissolved and/or a formation of said precipitates 42 is inhibited. Here, the electro-magnetic field 23 extends substantially into the cavity 300 such that the pickling solution 40 can be treated by the electro-magnetic field at least in a region of the wall 32, but may also extend through the cavity 300 into a further region of a further, e.g. opposing, wall 32′ (see. e.g. FIG. 3). Although the magnet arrangement 20 here is shown with only one magnet device 21, a plurality of magnet devices 21 may be arranged at the container means 30 accordingly. Here, the magnet device 21 comprises a permanent magnet or an electro magnet being arranged within a housing of the magnet device 21. Here, the magnet device has a first end 21′ and a second end 22″, wherein the magnet device 21 has an end face 22 at its' first end 21′. Here, the first end 21′ faces the wall 32 of the container means 30, wherein the electro-magnetic field passes through the end face 22 into the cavity 300. Preferably, the wall 32 and/or the end face 22 comprise a diamagnetic material, a plastic material, copper material, a glass material or other material. According to a first alternative, the end face 22 is an integral part of the wall 32, e,g, a window-like, e,g, diamagnetic, part of the wall and/or an integral part of the magnet device 21, or only one of the two.

FIG. 3 schematically shows an embodiment of the device 2 according to the present invention. Here, the device 2 is configured to generate an electro-magnetic field 23 substantially extending through the cavity 300 from the wall 32 to an opposing wall 32′, wherein the wall 32 and the opposing wall 32′ are preferably the walls of a pickling and/or regeneration equipment (11, 12, 13, 14, 15, 16) or a pipe of the piping 11′, 12′, 13′, 13″, 13′″, 14′, 14″, 15′, 15″, 16′ of the pickling apparatus 1. Here, the container means 30 is preferably a cylindrically shaped pipe 30, wherein the wall 32 and opposing wall 32′ are portions of a cylinder wall 32, 32′ being arranged around an axis 103. Here, the container means 30 and/or the cavity mainly extends along the axis 103′ being parallel to the longitudinal or Z-direction 103.

The magnet device 21 is arranged at the wall 32 and a further magnet device 21′ is arranged at the opposing wall 32′ opposite to the first magnet device 21 such that a homogeneous magnetic field 23 is generated by the two magnet devices 21, 21′. Preferably, the two magnet devices 21, 21′ are electro magnets configured to generate an oscillating magnetic field having an alternating field direction. Preferably, an oscillation amplitude and/or oscillation frequency is changed in time such that precipitates 42 formed by the silicon compounds 41 are dissolved and/or a formation of said precipitates 42 is inhibited. Here, for example, the precipitates are deposits at the opposing wall 32′, but may be anywhere in the container means 30, thereby obstructing the container means 30. Here, due to the treatment of the pickling solution with the magnetic field, the precipitates are dissolved and/or the precipitation of the silicon compounds 41 into the precipitates 42 is advantageously inhibited by the inventive device 2 and/or method.

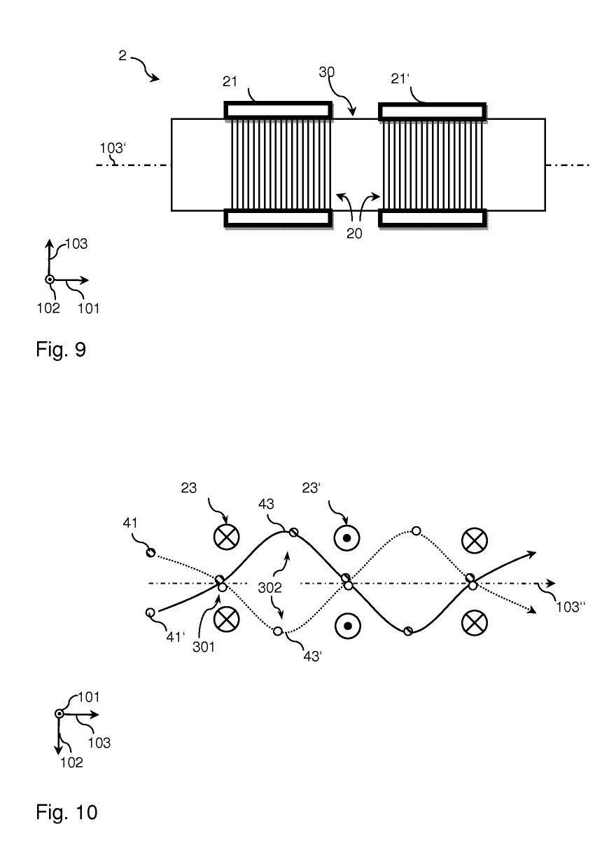

FIG. 4 schematically shows an embodiment of the device 2 according to the present invention. Here, the device 2 comprises a controlling means 24, wherein the controlling means 24 is configured to control the magnet devices 21, 21′, 21″, 21′″ of the magnet arrangement 20, e.g. by controlling the current signal and/or other signals supplied to the magnet devices 21, 21′, 21″, 21′″. Moreover, the device 2 comprises a sensor 25, here disposed within the container means 30, being configured to measure a solution property of the pickling solution 40. Preferably, the electro-magnetic field 23, 23′ is varied in time and/or space depending on the measured solution property such that said precipitates 42 are dissolved and/or such that a formation of said precipitates 42 is inhibited. In particular, the solution property is a flow direction 103″ (see e.g. FIGS. 9 and 10), flow speed, electrical conductivity, surface tension, composition and/or ionic strength of the pickling solution 40. The controlling means 24 and/or sensor means 25 are preferably fixedly attached within a housing of the device 21 and/or configured to communicate with a central monitoring and control unit of the pickling apparatus 1 via a wireless or wired communications link.

The magnet arrangement 20 according to the embodiment shown in FIG. 4 comprises a first pair of magnet devices 21, 21′ and a second pair of magnet devices 21″, 21′″, wherein both pairs of magnet devices, 21, 21′, 21″, 21′″ are preferably arranged in a row along a straight line parallel to the longitudinal direction 103 or Z-direction. Here, the first pair of magnet devices 21, 21′ is configured to generate a first, preferably homogeneous, magnetic field 23 and the second pair of magnet devices 21″, 21′″ is configured to generated a second, preferably homogeneous, magnetic field 23′. Preferably, the first and second magnetic fields 23, 23′ are oscillated out of phase, preferably in phase opposition to each other.

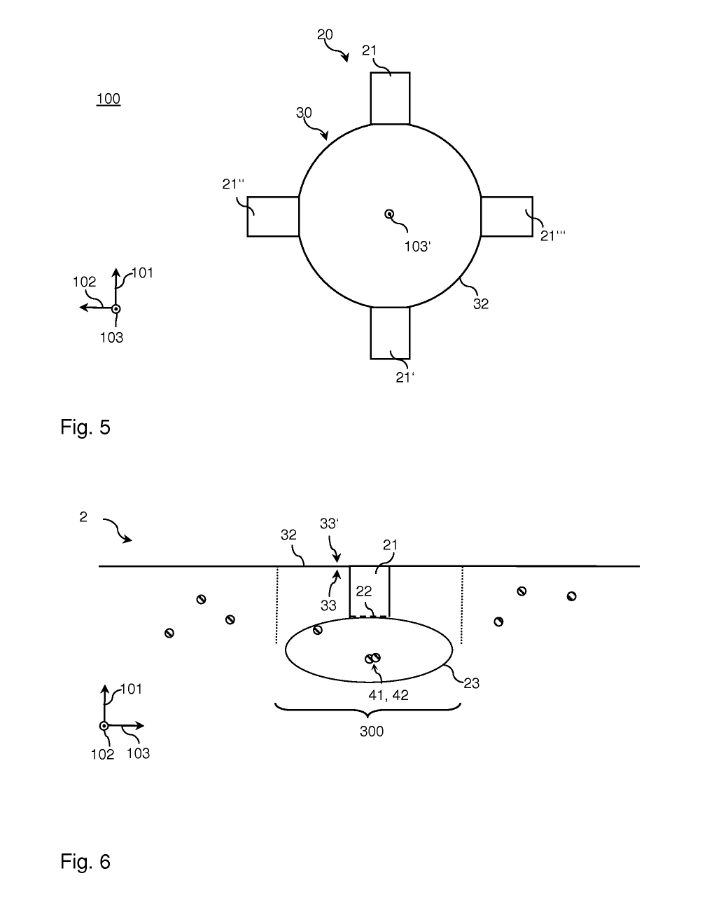

FIG. 5 schematically shows an embodiment of the device 2 according to the present invention. According to this embodiment, one or more magnet devices 21, 21′, 21″, 21′″, here a first pair 21, 21′ and a second pair 21′, 21′″ of said one or more magnet devices, are arranged at the wall 32 of the container means 30, which is here in particular a pipe 30 of the pickling apparatus 1. Here, said one or more magnet devices 21, 21′, 21″, 21′″ are circumferentially arranged around the axis 103′ within a transverse plane 100 being substantially perpendicular to the Z-direction 103 and/or preferably parallel to a cross section of the pipe 30. It is preferred according to the present invention, that said magnet devices 21, 21′, 21″, 21′″ are arranged such that a resonant pulsation of the pickling solution 40 is generated by the electro-magnetic field 23, 23′ and/or a flow of the pickling solution 40 is changed by the electro-magnetic field 23, 23′. Preferably, the pickling solution 40 flows at a flow speed in a flow direction 103″ parallel to the axis 103′, wherein the device is configured to turn the flow direction by preferably 90 degrees towards the wall and/or 180 degrees into a direction antiparallel to the flow direction 103″.

FIG. 6 schematically shows an embodiment of the device 2 according to the present invention, where the magnetic device 21 is arranged within the container means 20 at an inner side 33 of the wall 32. This placement of the device 2 within a container means is preferred, when the wall 32 of the container means 30 is a ferromagnetic material having relatively high electromagnetic permeability, e.g. of the order of 10,000.

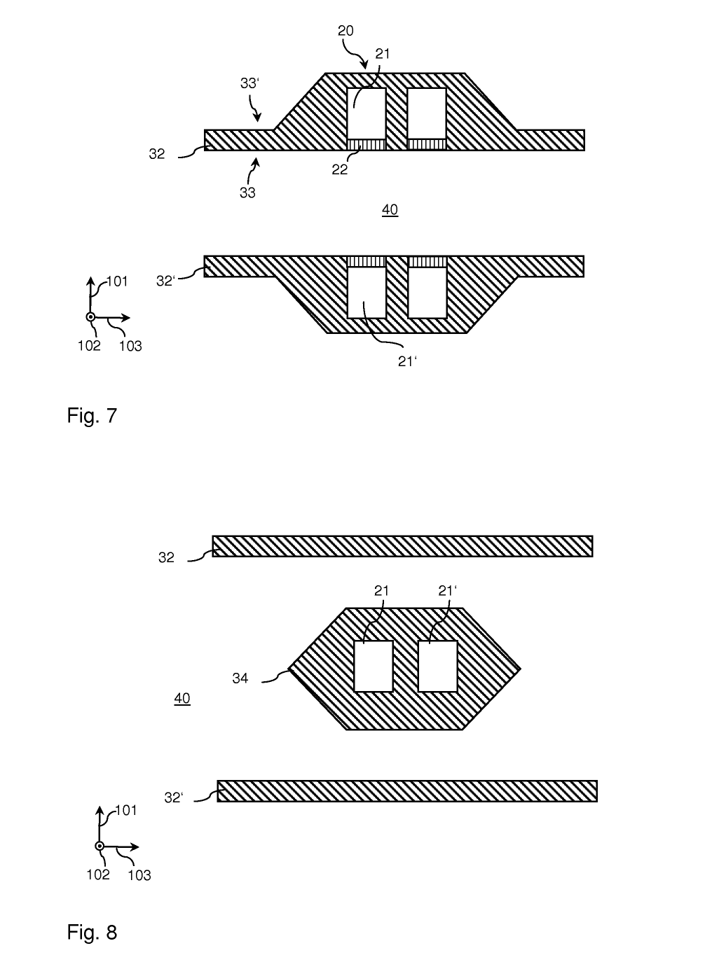

FIGS. 7 and 8 schematically show embodiments of the device 2 according to the present invention, which substantially correspond to the embodiments described in FIGS. 1 to 5. Here, the magnet devices 21, 21′ are arranged within the wall 32 and/or opposing wall 32 and/or within a box element 34, preferably a hermetically sealed box element 34 disposed within the container means 30. Preferably, the magnet devices 21, 21′ are removable via a plug-connection from the outer side 33′ thereby reducing the maintenance efforts.

FIG. 9 schematically shows an embodiment of the device 2 according to the present invention. Here, the magnet arrangement 20 comprises one or more, here two, magnet devices 21, 21′, arranged along the axis 103′ of the pipe 30, wherein said one or more magnet devices 21, 21′ are electro magnets, preferably winding spools being coiled around the pipe 30. It is thereby advantageously possible to create a homogeneous magnetic field 23, 23′ being substantially parallel to the axis 103′ of the pipe and/or the flow direction. It is advantageously possible according to the present invention that by means of various combinations of the various embodiments according to the present invention the magnet arrangement 20 is configured to generate an electro-magnetic field such that the pickling solution 40 is treated by the electro-magnetic field 23, 23′ such that precipitates 42 formed by the silicon compounds 41 are dissolved and/or a formation of said precipitates 42 is inhibited.

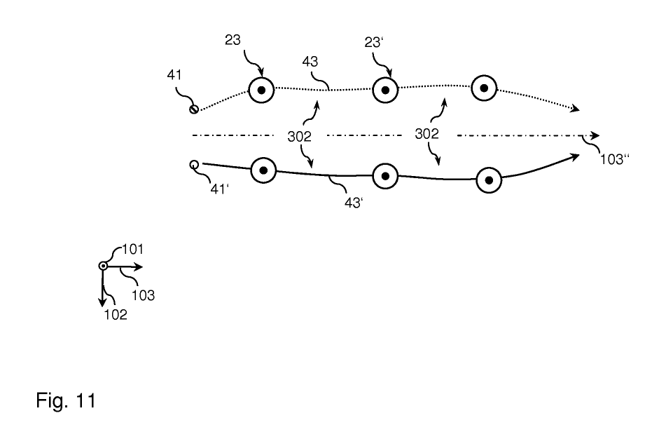

FIG. 10 schematically shows a pathway of, preferably magnetized, particles 41, 41′ during the treatment of the pickling solution 40 according to the present invention. According to this example, the silicon compounds 41 are negatively charged and counter-ions 41′, e.g. metal compound counter-ions 41′ are positively charged. Here, a first magnetic field 23 and a second magnetic field 23′ comprise field lines being substantially oriented into antiparallel directions. The pickling solu-tion 40 flows at a flow speed into a flow direction 103″ through the container means 30, wherein the flow direction is substantially parallel to a main direction of extension of the wall 32 and/or substantially parallel to the axis 103′ of the pipe 30. Here, the silicon compounds 41 and counter-ions 41′ are moved on separate, preferably substantially sinusoid, pathways 43, 43′ such that the silicon compounds 41 and counter-ions 41′ are separated from each other (as indicated by arrows 302) and collided back onto each other (as indicated by arrows 301) during their passage along the container means 30. In this way, it is advantageously possible to generate a flow of the silicon compounds 41 and metal compounds 41′ towards the wall 32, 32′. The magnetic field 23, 23′ may further be varied in time to produce similar effects. FIG. 11 schematically shows a pathway of, preferably magnetized, particles 41, 41′ during the treatment of the pickling solution 40 according to the present invention, where the silicon compounds 41 and counter-ions 42 are constantly separated from each other during their passage along the flow direction 103″. It is preferred according to the present invention that in the third step, the pickling solution 40 is treated by an inhomogeneous electro-magnetic field 23, 23′, wherein an electro-magnetic force is exerted onto the magnetized particles 41, 41′ by the inhomogeneous electro-magnetic field, wherein the precipitates 42 formed by the silicon compounds 41 are dissolved and/or a formation of said precipitates 42 is restrained depending on the electro-magnetic force exerted onto the magnetized particles 41, 41′.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### REFERENCE SIGNS

1 Pickling apparatus

2, 2′, 2″ Device

3 Silicon steel material

11 Pickling bath device

11′ Pipe

12 Acid regeneration device

12′ Pipe

13 Rinsing device

13′, 13″, 13′″ Pipes

14 Mixing device

14′, 14″ Pipes

15 Concentrator device

15′, 15″ Pipes

16 on exchange loop device

16′ Pipes

20 Magnet arrangement

21, 21′, 21″, 21″ Magnet devices

22 End face

22′ First end

22″ Second end

23, 23′ Electro-magnetic field

24 Control means

25 Sensor

30 Container means

32, 32′ Wall

33 Inner side

33′ Outer side

34 Box element

40 Pickling solution

41 Silicon compounds/Silicon compound ions

41′ Counter-ions

42 Precipitates

43 First pathway

43′ Second pathway

100 Transverse plane

101 X-direction

102 Y-direction

103 Z-direction/Longitudinal direction

103′ Axis

103″ Flow direction

300 Cavity

301 Collision

302 Separation

1. A method of treating a pickling solution for a pickling process, the pickling solution including a silicon compound dispersed in the pickling solution, the method comprising:
first, providing the pickling solution to a cavity of a container;
second, creating an electro-magnetic field within the container, the electro-magnetic field substantially extending within a cavity of the container; and
third, treating the pickling solution by the electro-magnetic field such that one or more precipitates formed by the silicon compound are dissolved and/or a formation of the precipitates is restrained.

2. The method of claim 1, wherein the treating, includes generating a resonant pulsation of the pickling solution using the electro-magnetic field.

3. The method of claim 1, wherein the treating includes providing an oscillating electro-magnetic field having an oscillation frequency and an oscillation amplitude,
wherein the oscillation frequency and/or oscillation amplitude is varied in time such that the precipitates are dissolved and/or the formation of the precipitates is inhibited.

4. The method of claim 1, wherein the treating includes providing a homogeneous electro-magnetic field, wherein the electro-magnetic field is varied along a longitudinal direction of the container, and
wherein the cavity and/or container mainly extends along the longitudinal direction.

5. The method of claim 1, wherein the treating includes modulating an electro-magnetic field with a modulation signal having a modulation frequency and/or a modulation amplitude and/or a modulation phase,
wherein the modulation frequency and/or the modulation amplitude and/or the modulation phase of the modulation signal is/are varied in time such that the precipitates (42) are dissolved and/or the formation of the precipitates is inhibited.

6. The method of claim 1, wherein the electro-magnetic field includes a signal having a sine-wave pattern, triangle-wave pattern, sawtooth-wave pattern, or square-wave pattern.

7. The method of claim 1, wherein the providing includes conveying the pickling solution through the cavity of the container along a flow direction substantially parallel to a longitudinal direction of the cavity and/or container,
wherein a flow of the pickling solution is reversed by the electro-magnetic field into a direction antiparallel to the flow direction utilizing a magnet arrangement of one or more magnet devices, arranged along the longitudinal direction in or at the cavity and/or circumferential around an axis, and
wherein the axis is substantially parallel to the longitudinal direction.

8. The method of claim 1, further comprising, after the treating:
separating one or more silicon compound ions and/or counter-ions, comprising in the pickling solution, from each other using the electro-magnetic field, the silicon compound ions and/or counter-ions being separated depending on a variation of the magnetic field in time and/or space.

9. The method of claim 1, wherein the treating includes measuring a solution property of the pickling solution using a sensor, and
wherein the electro-magnetic field is varied in time and/or space depending on the solution property measured, such that the precipitates are dissolved and/or a formation of the precipitates is inhibited.

10. A device for treating a pickling solution for a pickling process, the device comprising:
a magnet arrangement; and
a container,
wherein the container includes a cavity,
wherein the magnet arrangement is configured to create an electro-magnetic field substantially extending into the cavity of the container,
wherein the device is configured to treat the pickling solution, including a silicon compound, provided to the cavity using the electro-magnetic field, such that one or more precipitates formed by the silicon compound are dissolved and/or a formation of the precipitates is inhibited.

11. The device of claim 10, wherein the container includes a wall at least partially surrounding the cavity,
wherein the magnet arrangement includes a magnet device, wherein the magnet device is arranged at the wall, and
wherein the magnet device is disposed on an inner side of the wall of the container, on an outer side of the wall of the container, within the wall of the container, and/or within a box element within the cavity.

12. The device of claim 10, wherein the magnet device includes at least two magnet devices, which are arranged linearly along a longitudinal direction and/or circumferential around the cavity.

13. The device of claim 10, further comprising:
a control unit, and/or
a sensor,
wherein the control unit is configured to control the magnet arrangement, and/or
wherein the sensor is configured to measure a solution property of the pickling solution.

14. A pickling apparatus for pickling of a silicon steel material in a pickling solution, the pickling apparatus comprising:
a pickling bath device;
an acid regeneration device;
a rinsing device;
a mixing device;
a concentrator device; and/or
a piping,
wherein at least one device of claim 10 is arranged in, on, and/or at the pickling bath device, the acid regeneration device, the rinsing device, the mixing device, the concentrator device, and/or the piping.

15. The apparatus of claim 14, wherein the container of the device (2, 2′, 2″) is an integral part of the pickling bath device, the acid regeneration device, the rinsing device, the mixing device, the concentrator device, or the piping.

16. The method of claim 1, wherein the treating includes providing an inhomogeneous electro-magnetic field,
wherein the electro-magnetic field is varied along a longitudinal direction of the container, and
wherein the cavity and/or container mainly extends along the longitudinal direction.

17. The method of claim 8, further comprising colliding the silicon compound ions and/or counter-ions depending on a variation of the magnetic field in time and/or space.

18. The method of claim 8, wherein in the separating and/or colliding, the silicon compound ions and/or counter-ions are moved on spiral, linear, and/or sinusoid pathways.

19. The method of claim 9, wherein the solution property includes a flow direction, flow speed, electrical conductivity, surface tension, composition, and/or ionic strength of the pickling solution.
